(19) United States
(12) Patent Application Publication
(10) Pub. No.: US 2022/0251478 A1
(43) Pub. Date: Aug. 11, 2022

(54) Laundry Composition

(71) Applicant: Reckitt Benckiser Vanish B.V., Hoofddorp (NL)

(72) Inventors: Fabiola BIROLO, Mira (IT); Eleonora BOCCALETTO, Mira (IT); Giorgio CONTON, Mira (IT); Silvia GALLINARO, Mira (IT); Sara QUAGGIA, Mira (IT); Elisa SCOMPARIN, Mira (IT); Luca SPADONI, Mira (IT)

(73) Assignee: Reckitt Benckiser Vanish B.V., Hoofddorp (NL)

(21) Appl. No.: 17/625,324

(22) PCT Filed: Jul. 8, 2020
(86) PCT No.: PCT/GB2020/051634

§ 371 Date: Jan. 6, 2022

(30) Foreign Application Priority Data
Jul. 9, 2019 (GB) 1909822.7

(51) Int. Cl. C11D 3/386; C11D 11/00; C11D 1/825; C11D 3/04; C11D 3/34; C11D 3/20

(52) U.S. Cl. CPC C11D 3/38618; C11D 11/0017; C11D 1/825; C11D 3/044; C11D 1/722; C11D 3/38636; C11D 3/38645; C11D 3/2086; C11D 3/34

(57) ABSTRACT

The present invention relates to laundry composition comprising one or more non-ionic surfactants and a combination of enzymes, wherein the combination of enzymes comprises at least one amylase, at least one mannanase, at least one lipase, at least one endocellulase, and at least one exocellulase. The invention also relates to a method for washing a garment. The invention further relates to the use of the laundry composition according to the invention as an auxiliary of a laundry detergent composition. The further relates to the use of the laundry composition according to the invention for the washing of clothes in a washing machine, wherein the clothes comprise at least 50 wt. % of cotton, based on the total weight of the clothes.

The present invention relates to a laundry composition, to a method for washing a garment and to the use of said laundry composition.

### BACKGROUND

Consumers associate desirability and wearability of a garment with characteristics such as e.g. absence of wrinkles, absence of stains, absence of color fading, absence of unwanted pilling and loose threads, etcetera. It is preferred when one or more of these characteristics are achieved in a simple way and preferably after treating or washing a garment after only one time.

Regular laundry compositions are useful for cleaning clothes, meaning that grime and dirt are removed. However, for the removal of stains and unwanted pilling and loosed threads, additional laundry compositions need to be used. Current laundry compositions either eliminate unwanted pilling and loose threads from garments or remove stains from these. In addition, these results are not always achieved after only one wash.

Document EP 1123374 A1 describes fabric care compositions, which after being applied to a garment would produce a garment having some of the above-mentioned characteristics. However, this document is silent about removal of stains, grim, dirt, unwanted pilling and loose threads at the same time and after only one wash of said garment.

Therefore, there is a need of a laundry composition that not only removes grime and dirt but that also eliminates unwanted pilling and loose threads from garments and that at the same time removes stains, after only one wash. With other words, there is a need of a laundry composition, which after only one wash, provides a combined effect of eliminating unwanted pilling and loose threads for a smooth look and feel of a garment, and removing stains and breaking of down dirt and grime, leading to a grime leaving color vibrant.

It is an object of the present invention to provide a laundry composition that breaks down dirt and grime, eliminates unwanted pilling and loose threads from garments and removes stains, after only one wash.

It is an object of the present invention to provide a method for washing a garment for the removal of dirt and grime, elimination of unwanted pilling and loose threads and removal of stains from the garment.

### SUMMARY OF THE INVENTION

In a first aspect, the present invention relates to a laundry composition comprising one or more non-ionic surfactants and a combination of enzymes, wherein the combination of enzymes comprises at least one amylase, at least one mannanase, at least one lipase, at least one endocellulase, and at least one exocellulase.

In one embodiment, the composition comprises between 0.01 and 5 wt.c)/0 of the at least one mannanase, preferably between 0.1 and 1 wt. %, based on the total weight of the composition; and/or between 0.01 and 5 wt. % of the at least one lipase, preferably between 0.1 and 1 wt. %, based on the total weight of the composition; and/or between 0.1 and 10 wt. % of the at least one exocellulase, preferably between 1 and 3 wt. %, based on the total weight of the composition; and/or between 1 and 15 wt. % of the at least one endocellulase, preferably between 3 and 10 t. %, more preferably between 4 and 5 wt. %, based on the total weight of the composition; and/or between 0.01 and 5 wt. % of the at least one amylase, preferably between 0.1 and 1 wt. %, based on the total weight of the composition.

In an embodiment, the composition comprises between 1 and 30 wt. % of the one or more non-ionic surfactants, preferably between 5 and 20 wt. %, more preferably between 10 and 15 wt. %, based on the total weight of the composition.

The pH of the composition may be of between 6 and 8; preferably between 6.5 and 7.5.

The one or more non-ionic surfactants may have the formula R¹(OCH₂CH₂)ₙOH; wherein R¹ is an alkyl moiety having between 10 and 24 carbon atoms, and n has an average value of from 1 to 10.

The laundry composition may be a mono-phase composition or a dual-phase composition.

In an embodiment, the laundry composition is a mono-phase composition, wherein the one or more non-ionic surfactants may be chosen from the group consisting of non-ionic surfactants in which R¹ is a C₁₂₋₁₄ moiety and n is 7, non-ionic surfactants in which R¹ is a C₁₂₋₁₆ moiety and n is 3, and non -ionic surfactants in which R¹ is a C₁₂₋₁₆ moiety and n is 5, or combinations thereof. The composition may further comprise an anionic surfactant; for example, the composition may comprise between 1 and 10 wt. % of the anionic surfactant, preferably between 3 and 5 wt. %, based on the total weight of the formulation.

In another embodiment, the composition is a dual-phase composition, wherein the one or more non-ionic surfactants may be a non-ionic surfactant in which R¹ is a C₁₃ moiety and n is 3. The one or more non-ionic surfactants may have an H LB number of between 7 and 10, preferably between 7 and 9, more preferably between 7 and 8, for example around 8.

In a second aspect, the invention relates to a method for washing a garment comprising the steps of:
washing a garment with the composition according to the first aspect of the invention; or
washing a garment with a mixture comprising a laundry detergent composition and the composition according to the first aspect of the invention; or
a) pre-treating the garment with the composition according to the first aspect of the invention; and
b) washing the pre-treated garment of step a) with the composition according to the first aspect of the invention, or a laundry detergent composition, or a mixture comprising a laundry detergent composition and the composition according to the first aspect of the invention;
wherein the garment comprises at least 50 wt. % of cotton, based on the total weight of the garment, preferably at least 60 wt. %, more preferably at least 70 wt. %, even more preferably at least 80 wt. %; such as for example 100 wt. %.

In a third aspect, the invention relates to a use of the laundry composition according to the first aspect as an auxiliary of a laundry detergent composition.

In a fourth aspect, the invention relates to a use of the laundry composition according to the first aspect for the washing of clothes in a washing machine, wherein the clothes comprise at least 50 wt. % of cotton, based on the total weight of the clothes, preferably at least 60 wt. %, more preferably at least 70 wt. %, even more preferably at least 80 wt. %; such as for example 100 wt. %.

Definitions

The following definitions are used in the present application.

“Rejuvenation of clothes” or “Rejuvenation of a garment” as used in the present application means: treatment or washing of clothes or a garment to eliminate dirt and grime, eliminate unwanted pilling and loosed threads and to remove stains. Wth other words, it is the treatment of clothes or a garment to provide the combined effect of eliminating dirt and grime, eliminating unwanted pilling and loose threads and removing stains.

“Soft water” as used in the present application means: water having a content of calcium carbonate, CaCO₃, of less than 60 ppm, preferably less than 50 ppm.

“Amylases” as used in the present application means: class of enzymes that catalyze the hydrolysis of starch into sugars such as glucose and maltose.

“Mannanases” as used in the present application means: class of enzymes that catalyze the hydrolysis of mannose derivatives.

“Mannose” as used in the present application means: sugar monomer of the aldohexose series of carbohydrates.

“Lipases” as used in the present application means: class of enzymes that catalyze the hydrolysis of fats or lipids.

“Cellulase” as used in the present application means: class of enzymes that catalyze the cellylolysis or hydrolysis of cellulose.

“Endocellulases” as used in the present application means: class of cellulases that hydrolyze glycoside links within cellulose chains.

“Exocellulases” as used in the present application means: class of cellulases that hydrolyze glycoside links at the ends of cellulose chains.

“Laundry composition” as used in the present application means: compositions which can be used for pre-treating a garment before washing the garment with a laundry detergent, and/or that can be used alone for washing a garment, and/or that can be used together with the laundry detergent during washing of the garment, and/or that can be used as a rinse cycle composition. Wth other words, the laundry composition can be used alone for washing a garment or can be used as an auxiliary of the laundry detergent. A laundry composition includes, but is not limited to, products for the care of garments, removal of stains and elimination of unwanted pilling from garments, cleaning of garments, sanitisation of garments, disinfecting of garments, stain removers, water softening in washing machines, fabric softening in washing machines and dryers, pot/stain removal, ironing aids, pre and post wash treatments, machine cleaning and maintenance, carpet cleaners and treatments.

“Laundry detergent composition” as used in the present application means: composition used solely for the cleaning of garments and whose main action is the removal of grim and dirt, comprising a builder and not having lipases.

### DETAILED DESCRIPTION OF THE INVENTION

In a first aspect the present invention relates to a laundry composition comprising one or more non-ionic surfactants and a combination of enzymes, wherein the combination of enzymes comprises at least one amylase, at least one mannanase, at least one lipase, at least one endocellulase, and at least one exocellulase.

This specific combination of non-ionic surfactants and enzymes is responsible for the rejuvenation of a garment, i.e. the combined effect of elimination of grime and dirt, stain removal and elimination of unwanted pilling and loose threads from garments.

The composition may comprise, for example:
between 0.01 and 5 wt. % of the at least one mannanase, preferably between 0.1 and 1 wt. %, based on the total weight of the composition; and/or
between 0.01 and 5 wt. % of the at least one lipase, preferably between 0.1 and 1 wt. %, based on the total weight of the composition; and/or
between 0.1 and 10 wt. % of the at least one exocellulase, preferably between 1 and 3 wt. %, based on the total weight of the composition; and/or
between 1 and 15 wt. % of the at least one endocellulase, preferably between 3 and 10 t. %, more preferably between 4 and 5 wt. %, based on the total weight of the composition; and/or
between 0.01 and 5 wt. % of the at least one amylase, preferably between 0.1 and 1 wt. %, based on the total weight of the composition.

Non-Ionic Surfactant

The amount of the one or more non-ionic surfactants in the laundry composition may be between 1 and 30 wt. %, preferably between 5 and 20 wt. %, more preferably between 10 and 15 wt. %, based on the total weight of the composition. Examples of non-ionic surfactants are ethoxylated alcohols and ethoxylated alkyl phenols having the formula R¹(OCH₂CH₂)ₙOH; wherein R¹ is an aliphatic hydrocarbon radicals containing between 10 and 24 carbon atoms or alkyl phenyl radicals in which the alkyl groups contain from 10 to 22 carbon atoms; and n has an average value of from 1 to 10. Preferably, the one or more non-ionic surfactants have the formula R¹(OCH₂CH₂)ₙOH; wherein R¹ is an alkyl moiety having between 10 and 24 carbon atoms, and n has an average value of from 1 to 10.

For example, when R¹ is defined as being a C₁₂₋₁₄ moiety, it is meant an alkyl moiety having between 12 and 14 carbon atoms. For example, when R¹ is defined as being a C₁₂₋₁₆ moiety, it is meant an alkyl moiety having between 12 and 16 carbon atoms. For example, when R¹ is defined as being a C₁₃ moiety, it is meant an alkyl moiety having 13 carbon atoms.

For example, when n is defined being 7, it is meant that n has an average value of 7. For example, when n is defined as being 3, it is meant that n has an average value of 3. For example, when n is defined as being 5, it is meant that n has an average value of 5.

An Example of a non-ionic surfactant having the formula R¹(OCH₂CH₂)ₙOH; wherein R¹ is a C₁₂₋₁₄ moiety and n is 7, is Marlipal 24/70 by Sasol.

An Example of a non-ionic surfactant having the formula R¹(OCH₂CH₂)ₙOH; wherein R¹ is a C₁₂₋₁₆ moiety and n is 3, is Novel 1216 CO-3 by Sasol.

An Example of a non-ionic surfactant having the formula R¹(OCH₂CH₂)ₙOH; wherein R¹ is a C₁₂₋₁₆ moiety and n is 5, is AEO 5-24Z by Sasol.

An Example of a non-ionic surfactant having the formula R¹(OCH₂CH₂)ₙOH; wherein R¹ is a C₁₃ moiety and n is 3, is product Marlipal® O 13/30 by Sasol.

The composition may include one or more additional ingredients selected from the group consisting of chelating agents, organic solvents, dye-transfer inhibitors, anti-fading agents, anti-bacterial agents, preservatives, fabric softeners, anti-static agents, fragrances, odor absorbing components, pH modifiers, thickeners, dyes, and optical brighteners.

Chelating Agent

The composition may include a chelating agent such as water-soluble polyphosphonates, such as diphosphonates including sodium, potassium, and lithium salts of ethane-1-hydroxy-1,1-diphosphonic acid; sodium, potassium and lithium salts of methylenediphosphonic acid; sodium, potassium salts of hydroxyalkylidene diphosphonic acids, and the like.

The chelating agent may also be dialkylene polyacetic acids or salts thereof, for example, diethylene pentacetic acid or a salt thereof, such as the pentasodium salt.

Optionally the chelating agent is an acrylic acid/acrylate polymer, for example polyacrylic acid or a copolymer which includes acrylic acid as a monomer unit

A preferred class of of chelating agents, especially in the acidic liquid, is the alkali metal salts of aliphatic hydroxydi- or hydroxy-tricarboxylic acids. Suitable compounds include the alkali metal salts of malic, tartaric, isocitric, trihydroxyglutaric and, especially, citric acid. Sodium salts are generally preferred. An especially preferred compound of this class is sodium citrate.

Some chelating agents, such as 3 sodium citrate, are also used as pH modifiers.

When one or more chelating agents are present in the composition, it is present in a range of between 1 and 10 wt. %, preferably between 2 and 9 wt. %, more preferably between 3 and 7 wt. %, based on the total weight of the composition.

Organic Solvent

The organic solvent may be any organic solvent, although it is desirable that it is miscible with water. Examples of organic solvents are glycols, glycerine or an alcohol. It is preferred that the organic solvent is glycerin.

Glycerin, besides being an organic solvent is also an enzyme stabilizer.

When an organic solvent is present in the composition, it is present in a range of between 5 and 30 wt. %, preferably between 7 and 25 wt. %, based on the total weight of the composition. For example, the organic solvent can be present in a range of between 10 and 20 wt. %, based on the total weight of the composition; or the organic solvent can be present in a range of between 9 and 15 wt. %, based on the total weight of the composition. Preferably said organic solvent is glycerin.

pH Modifier

The compositions according to the invention may also comprise a pH modifier, i.e. a source of acidity or a source of alkalinity, to obtain the desired pH, on dissolution. A source of acidity may suitably be any suitable acidic compound for example a polycarboxylic acid. For example, a source of alkalinity may be a carbonate or bicarbonate (such as the alkali metal or alkaline earth metal salts). A source of alkalinity may suitably be any suitable basic compound for example any salt of a strong base and a weak acid. When an alkaline composition is desired silicates are amongst the suitable sources of alkalinity. Materials commonly used as a source of alkalinity are NaOH (sodium hydroxide), and Tri- Di or Monoethanolamine; while sulfuric acid is commonly used as a source of acidity. Conventional amounts of the alkalinity or acidity source may be used.

For example, the laundry compositions according to the invention may comprise between 0.5 wt. % and 10 wt. % of a pH modifier, for example between 0.5 wt. % and 5 wt. %, based on the total weight of the formulation.

The laundry composition has a pH of, for example, of between 6 and 8, preferably between 6.5 and 7.5.

It should be noted that the present inventors have observed that the pH influences the efficacy of the formulation. For example, at a pH higher than approximately 8 and lower than approximately 6, the performance of the formulation decreases, i.e. the elimination of unwanted pilling and loose threads from garments and/or the removal of stains. Furthermore, the inventors have observed that activity of endocellulases is the best within a pH ranging from between 6 to 8.

Anionic Surfactant

The composition may further comprise any conventional anionic surfactant or a mixture of them used in detergent products. These include, for example, the alkyl benzene sulfonic acids and their salts as well as alkoxylated or non-alkoxylated alkyl sulfate materials. The anionic surfactants may be present in acid form or in neutralized (e.g., salt) form. The anionic surfactants may be linear, branched, or a mixture thereof. An example of an anionic surfactant is sodium cumenesulphonate.

Examples of anionic surfactants are the alkali metal salts of C₁₀₋₁₆ alkyl benzene sulphonic acids or C₁₁₋₁₄ alkyl benzene sulphonic acids.

Another exemplary type of anionic surfactant is alkoxylated alkyl sulphate surfactants, such as ethoxylated alkyl sulphate surfactants. Such materials are also known as alkyl ether sulphates or alkyl polyethoxylate sulphates.

Alkyl ether sulphates are generally available in the form of mixtures comprising varying R′ chain lengths and varying degrees of ethoxylation. Frequently such mixtures also contain some non- ethoxylated alkyl sulphate (“AS”) materials.

Mono-Phase Composition

In an embodiment, the laundry composition is a mono-phase composition, meaning that macroscopically the composition consists of one liquid phase. The mono-phase composition preferably comprises one or more non-ionic surfactants selected from the group consisting of non-ionic surfactants in which R¹ is a C₁₂₋₁₄ moiety and n is 7, non-ionic surfactants in which R¹ is a C₁₂₋₁₆ moiety and n is 3, and non -ionic surfactants in which R¹ is a C₁₂₋₁₆ moiety and n is 5, or combinations thereof. Furthermore, the mono-phase composition may further comprise an anionic surfactant, preferably in an amount of between 1 and 10 wt. % of an anionic surfactant, preferably between 3 and 5 wt. %, based on the total weight of the formulation.

The present inventors have observed that by adding one or more anionic surfactants to the laundry composition comprising one or more non-ionic surfactants, the performance of the laundry composition is improved; meaning that the rejuvenation of the clothing is improved; with other words, the combined effect of removal of grime and dirt, stain removal and elimination of unwanted pilling and loose threads from garments is improved, compared to the laundry composition comprising only one or more non-ionic surfactants.

In an embodiment, the laundry composition is an aqueous mono-phase composition comprising:
between 0.5-1.5 wt. % of a pH modifier;
between 3-4.5 wt. % of one or more anionic surfactants;
between 7-13 wt. % of one or more non-ionic surfactants, preferably selected from the group consisting of non-ionic surfactants in which R¹ is a C₁₂₋₁₄ moiety and n is 7, non-ionic surfactants in which R¹ is a C₁₂₋₁₆ moiety and n is 3, and non -ionic surfactants in which R¹ is a C₁₂₋₁₆ moiety and n is 5, or combinations thereof;
between 10-20 wt. % of an organic solvent, preferably glycerin;
between 0.1-1 wt. % of one or more mannanases;
between 0.1-1 wt. % of one or more lipases;
between 1-3 wt. % of one or more exocellulases;
between 4-5 wt. % of one or more endocellulases;
between 0.1-1 wt. % of one or more amylases,
between 1-5 wt. % of additional ingredients such as sequestrant, preservative, dyes and fragrance, preferably between 1-3 wt. %,
based on the total weight of the laundry composition.

Dual-Phase Composition

In another embodiment, the laundry composition is a dual-phase composition, meaning that macroscopically, when the composition is let to rest at room temperature, i.e. between 15° C. and 25 ° C., the composition separates into two phases, which macroscopically are two liquid phases. One of the liquid phases is rich on enzymes, while the other liquid phase is rich on the one or more non-ionic surfactants. The dual-phase composition preferably comprises one or more non-ionic surfactants being a non-ionic surfactant in which R¹ is a C₁₃ moiety and n is 3.

For the dual-phase composition it is preferred that the one or more non-ionic surfactants have an HLB number of between 7 and 10, preferably between 7 and 9, more preferably between 7 and 8, for example around 8. The inventors have observed that the HLB number of the one or more non-ionic surfactants influences the phase separation of the laundry composition.

In an embodiment, the laundry composition is an aqueous dual-phase composition comprising:
between 3-7 wt. % of a pH modifier;
between 9-15 wt. % of one or more non-ionic surfactants, preferably being a non-ionic surfactant in which R¹ is a C₁₃ moiety and n is 3; and preferably having a HLB number of between 7 and 10, for example, between 7 and 9, for example, between 7 and 8, such as for example around 8;
between 9-15 wt. % of an organic solvent, preferably glycerin;
between 0.1-1 wt. % of one or more mannanases;
between 0.1-1 wt. % of one or more lipases;
between 1-3 wt. % of one or more exocellulases;
between 4-5 wt. % of one or more endocellulases;
between 0-1-1 wt. % of one or more amylases;
between 1-5 wt. % of additional ingredients such as sequestrant, preservative, dyes and fragrance, preferably between 1-3 wt. %, based on the total weight of the laundry composition.

The inventors have observed that the dual-phase composition has the same efficacy regarding clothes rejuvenation as the one-phase composition.

In a second aspect, the invention relates to a method for washing a garment, comprising:
washing a garment with the composition according to the first aspect of the invention; or
washing a garment with a mixture comprising a laundry detergent composition and the composition according to the first aspect of the invention; or
a) pre-treating the garment with the composition according to the first aspect of the invention; and
b) washing the pre-treated garment of step a) with the composition according to any of the first aspect of the invention, or a laundry detergent composition, or with a mixture comprising a laundry detergent composition and the composition according to the first aspect of the invention;
wherein the garment comprises at least 50 wt. % of cotton, based on the total weight of the garment, preferably at least 60 wt. %, more preferably at least 70 wt. %, even more preferably at least 80 wt. %; such as for example 100 wt. %.

A garment may be washed by adding certain amount; e.g. 100 mL, of the composition according to the invention to a washing machine and washing the garment following a regular cycle of said machine.

Optionally, a garment may be washed with a mixture comprising a regular detergent composition and the laundry composition according to the invention. This mixture may be added to a washing machine and the garment may be then washed following a regular cycle of said machine. The proportion in weight of regular detergent composition to the laundry composition according to the invention in the mixture may be (weight of detergent composition:weight of composition according to the invention) 5:1, for example 4:1, preferably 3:1, or even 2:1 or 1:1.

A garment may be also washed by firstly pre-treating the garment with the composition according to the invention and then washing the pre-treated garment using a regular cycle of a washing machine to which, the composition according to the invention, or a regular laundry detergent composition or a mixture comprising a laundry detergent composition and the laundry composition according to the invention has been added. Said pre-treatment comprises for example applying certain amount of the composition according to the invention to a stain on the garment, allow the composition to act for certain amount of time, for example 10 minutes, and rubbing.

The present inventors have observed that although the washing of a garment with the composition according to the invention or with a mixture comprising a laundry detergent composition and the composition according to invention leads to a garment from which dirt, grime and stains are removed and unwanted pilling is eliminated, best results are obtained when the garment is pre-treated with the composition according to the invention and then washed.

Furthermore, the preset inventors have observed that to obtain the desired rejuvenation of a garment, the garment must comprise at least 50 wt. % cotton, based on the total weight of the garment, preferably at least 60 wt. %, more preferably at least 70 wt. %, even more preferably at least 80 wt. %; such as for example 100 wt. %.

In a third aspect, the invention relates to the use of the laundry composition according to the first aspect as an auxiliary of a laundry detergent composition.

A regular laundry detergent composition normally removes dirt and grim from clothes; however, when the composition according to the first aspect of the invention is used, either for pre-treating a garment or in a mixture comprising the laundry detergent composition, not only dirt and grim are removed from a garment, but also unwanted pilling and stains.

In a fourth aspect, the invention relates to the use of the laundry composition according to the first aspect of the invention, for the washing of clothes in a washing machine, wherein the clothes comprise at least 50 wt. % of cotton, based on the total weight of the clothes, preferably at least 60 wt. %, more preferably at least 70 wt. %, even more preferably at least 80 wt. %; such as for example 100 wt. %.

Therefore, in an aspect the invention relates to the use of the laundry composition according to the first aspect of the invention for the rejuvenation of clothes.

In a further aspect, the composition according to the first aspect of the invention is in a unit dose form, for example, the composition may be contained in a water-insoluble sachet or container.

The invention will be further described, by way of example, with the reference to the following non-limiting embodiments.

### EXAMPLES

Formulations

A mono-phase and a dual-phase formulation according to the invention were prepared. Formulation 1 is the mono-phase formulation and formulation 2 is the dual-phase formulation.

Formulation 1 (Mono-Phase Laundry Composition)

Formulation 1 was prepared by mixing the components shown in Table 1.

TABLE 1
Mono-phase laundry composition

| Component | wt. % |
|---|---|
| Caustic Soda | 1.25 |
| Sulfonic Acid | 3.75 |
| Non-ionic surfactants | 9.63 |
| Glycerin, 98% | 15.00 |
| Mannanase | 0.55 |
| Lipase | 0.55 |
| Exocellulase | 2.00 |
| Endocellulase | 4.50 |
| Amylase | 0.55 |
| Additional ingredients | 1.10 |
| Soft Water | Up to 100% |

The pH of formulation 1 was measured and this value was 6.5±0.5.

The viscosity of formulation 1 was measured with a Brookfield rheometer DV-II+Pro, at 20 rpm at 20° C., and this value was 350 cP±100 cP.

In formulation 1, specification of the components is the following:
Caustic soda: sodium hydroxide solution of 50% in H₂O by Anwil S.A.
Sulfonic acid: sulfonic acid solution with 96% purity by SASOL Italy S.P.A.
Non-ionic surfactants: mixture of
   C12-C14 fatty acid alcohol with an average ethoxylation of 7, being Marlipal 24/70 by Sasol;
   C12-C16 alcohol with an average ethoxylation of 3, being Novel 1216 CO-3 by Sasol;
   C12-C16 alcohol with an average ethoxylation of 5, being AEO 5-24Z by Sasol.
Mannanase: Mannan endo-1,4-beta-mannosidase.
Amylase: α-amylase.
Additional ingredients: sequestrant, preservative, dyes and fragrance.

Formulation 2 (Dual-Phase Laundry Composition)

Formulation 2 was prepared by mixing the components shown in Table 2.

TABLE 2
Dual-phase laundry composition

| Component | wt. % |
|---|---|
| 3 Sodium citrate | 5.00 |
| Non-ionic surfactants | 12.00 |
| Glycerin, 99.5% | 15.00 |
| Mannanase | 0.55 |
| Lipase | 0.55 |
| Exocellulase | 2.00 |
| Endocellulase | 4.50 |
| Amylase | 0.55 |
| Additional ingredients | 1.10 |
| Deionized water | Up to 100% |

The pH of formulation 2 was measured and this value was 6.5±0.5.

The viscosity of formulation 2 was measured with a Brookfield rheometer DV-II+Pro, at 100 rpm at 20° C., and this value was 15 cP ±100 cP.

In formulation 2, specification of the components is the following:
3 sodium citrate: trisodium citrate by Weifang Ensign.
Non-ionic surfactants: C13 fatty acid alcohol with an average ethoxylation of 3, being Marlipal® O13/30 by Sasol.
Mannanase: Mannan endo-1,4-beta-mannosidase.
Amylase: α-amylase.
Additional ingredients: sequestrant, preservative, dyes and fragrance.

PerformanceTests

Fabrics

Pre-Pilled Fabrics

Pre-pilled fabrics were used, which were 100% cotton. Samples were Fuzzed/Faded RTX 5177 PLO-Violet-Orange LightBlue (PLO) and Fuzzed/Faded RTX 5177 BRB Blue-Black-Red (BRB). These pre-pilled fabrics showed unwanted pilling.

Stained Fabrics

Standard stains on a fabric being 100% cotton were used.

Washings

The pre-pilled fabrics and the stained fabrics were washed in a washing machine, with the following specifications: Washing machine: Miele W3164; Washing program: cotton, Washing temperature: 40° C.; Drying method: Tumble drier.

The regular liquid detergent was Ariel Original Washing Liquid.
Washing A: with 35 mL of the regular liquid detergent added to the washing machine.

Washing B: with 35 mL of the regular liquid detergent and 36.7 mL of a composition not according to the invention for stain removal (OxiClean™); both added to the washing machine.

Washing C: with50 gr of a composition not according to the invention for removal of pilling (Lovables by Henkel) added to the washing machine.

Washing D: with 100 mL of a composition not according to the invention for removal of pilling (Woolite serum by Reckitt Benckiser) added to the washing machine.

Washing 1: with 100 mL of formulation 1 or formulation 2, i.e. composition according to the invention added to the washing machine.

Washing 2: with 35 mL of the regular liquid detergent and 100mL of either formulation 1 or formulation 2, i.e. the laundry composition according to the invention; added to the washing machine.

Washing 3: pre-treated of a stained fabric with 2 mL of either formulation 1 or formulation 2, i.e. the laundry composition according to the invention. The pre-treated stained fabric was washed with 35 mL of the regular liquid detergent and 98 mL of either formulation 1 or formulation 2, which were added to the washing machine.

The pre-treatment in washing 3 is performed by adding 2 mL of either formulation1 or formulation 2 to the stained fabric, waiting 10 minutes and then rubbing the stained fabric 5 times back and forth.

It should be noted that the total amount of either formulation 1 or formulation 2 used in washing 3 is 100 mL. This means that if three stained fabrics are pre-treated, then 2 mL of either formulation 1 or formulation 2 are used per stain, and 94 mL are used for the washing in the washing machine.

Pilling Removal After One Wash

Pre-pilled fabrics were treated according to the different “washings” as previously described. These fabrics were Fuzzed/Faded RTX 5177 PLO-Violet-Orange LightBlue (PLO) and Fuzzed/Faded RTX 5177 BRB Blue-Black-Red (BRB).

Removal of unwanted pilling and loose threads was determined visually. Results are shown in Table 3, in which “0” means no removal of unwanted pilling and loose threads, “+” means minimal or partial removal of unwanted pilling and loose threads, and “++” means complete removal of unwanted pilling and loose threads.

In addition, Table 3 shows the color brightness of the fabric pieces after treatment, which was visually determined. In this Table, brightness is measured in a scale of 1 to 4, in which “1” is a fabric piece with the highest brightness and “4” is a fabric piece with the least brightness.

TABLE 3
Pilling removal and color brightness

| | | | Removal of unwanted pilling |
|---|---|---|---|
| Example | Fabric | Washing | and loose threads |
| 1a* | BRB | A | 0 |
| 1b* | BRB | B | + |
| 1 | BRB | 2 | ++ |
| 2a* | PLO | A | 0 |
| 2b* | PLO | B | + |
| 2 | PLO | 2 | ++ |

Examples with an (*) are comparative examples, in which formulation not according to the invention were used.

From table 3, it is clear that the laundry composition according to the invention, either when used alone or in combination with a laundry detergent composition eliminates unwanted pilling and threads from clothes. This is also demonstrated because the treated clothes have a brightener appearance.

It must be noted that the same effects are obtained with a mono-phase laundry composition as with a dual-phase laundry composition.

Stain Removal After One Wash

Stained fabrics were treated according to different “washings” as previously described. In table 4, stain removal performance of different “washings” is compared with respect to stain removal of a regular liquid detergent, i.e. Washing A. In table 4, “0” means no difference regarding stain removal performance, compared to Washing A, “+” means improved stain removal performance.

TABLE 4
Stain removal after one wash

| | | Stain removal performance compared | | |
|---|---|---|---|---|
| | | to “Washing A” | | |
| Example | Stain | Washing 1 | Washing 2 | Washing 3 |
| 3 | Lipstick | + | + | + |
| 4 | Make-up | 0 | 0 | + |
| 5 | Motor oil used | 0 | + | + |
| 6 | Skin grease | + | + | + |
| 7 | Soot mineral | 0 | + | + |
| | oil | | | |
| 8 | Soy sauce | 0 | + | + |
| 9 | Chocolate Bar | + | + | + |
| 10 | Chocolate | + | + | + |
| | drink | | | |
| 11 | Cocoa drink | 0 | 0 | 0 |
| 12 | Corn starch | + | + | + |
| 13 | Potato starch | 0 | + | + |
| 14 | Carrot baby | 0 | 0 | + |
| | food | | | |
| 15 | Coffee | 0 | + | + |
| 16 | Grass empa | 0 | + | + |
| 17 | Grass/Mud | 0 | 0 | + |
| 18 | Mustard | + | + | + |
| 19 | Red wine | 0 | 0 | + |
| 20 | Spaghetti | + | + | + |
| | sauce with | | | |
| | meat | | | |
| 21 | Tea | 0 | + | + |
| 22 | Tomato puree | + | + | + |
| 23 | Cooked beef | | + | |
| | fat | | | |
| 24 | Sheep blood | | + | |
| 25 | Blueberry juice | | + | |

From table 4, it is clear that the laundry composition according to the invention, either when used alone, for pre-treating a garment, or in combination with a laundry detergent composition, removes stains from the clothes. It should be noted that this is achieved after just one wash of the garment or clothing.

This effect is obtained with a mono-phase laundry composition, and also with a dual-phase laundry composition.

The Examples show that the laundry composition according to the invention provides a combined effect of eliminating unwanted pilling and loose threads from garments and removing stains from these, after only one wash.

A garment can be then rejuvenated when it is washed with the laundry composition according to the invention; this rejuvenation is achieved after only one wash.

Hence one or more objects of the present invention are achieved by the present which is further elucidated in the appended claims.

1. A laundry composition comprising:
one or more non-ionic surfactants; and
a combination of enzymes,
wherein the combination of enzymes comprises at least one amylase, at least one mannanase, at least one lipase, at least one endocellulase, and at least one exocellulase.

2. The laundry composition according to claim 1, wherein the laundry composition between 0.01 and 5 wt. % of the at least one mannanase, based on the total weight of the laundry composition.

3. The laundry composition according to claim 1, wherein the laundry composition comprises between 0.01 and 5 wt. % of the at least one lipase, based on the total weight of the laundry composition.

4. The laundry composition according to claim 1, wherein the laundry composition comprises between 0.1 and 10 wt. % of the at least one exocellulasely, based on the total weight of the laundry composition.

5. The laundry composition according to claim 1, wherein the laundry composition comprises between 1 and 15 wt. % of the at least one endocellulase, more preferably between 4 and 5 wt. %, based on the total weight of the laundry composition.

6. The laundry composition according to claim 1, wherein the laundry composition comprises between 0.01 and 5 wt. % of the at least one amylase, based on the total weight of the laundry composition.

7. The laundry composition according to claim 1, wherein the laundry composition comprises between 1 and 30 wt. % of the one or more non-ionic surfactants, based on the total weight of the laundry composition.

8. The laundry composition according to claim 1, wherein the laundry composition has a pH of between 6 and 8.

9. The laundry composition according to claim 1, wherein the one or more non-ionic surfactants have the formula R¹(CH₂CH₂O)ₙOH; wherein R¹ is an alkyl moiety having between 10 and 24 carbon atoms, and n has a value of from 1 to 10.

10. The laundry composition according to claim 1, wherein the laundry composition is a mono-phase composition.

11. The laundry composition according to claim 10, wherein the one or more non-ionic surfactants are selected from the group consisting of non-ionic surfactants in which R¹ is a C₁₂₋₁₄ moiety and n is 7, non-ionic surfactants in which R¹ is a C₁₂₋₁₆ moiety and n is 3, and non -ionic surfactants in which R¹ is a C₁₂₋₁₆ moiety and n is 5, or combinations thereof.

12. The laundry composition according to claim 10, wherein the composition further comprises between 1 and 10 wt. % of an anionic surfactant, based on the total weight of the formulation.

13. The laundry composition according to claim 1, wherein the composition is a dual-phase composition.

14. The laundry composition according to claim 13, wherein the one or more non-ionic surfactants is a non-ionic surfactant in which R¹ is a C₁₃ moiety and n is 3.

15. The laundry Laundry composition according to claim 13, wherein the one or more non-ionic surfactants have an HLB number of between 7 and 10.

16. A method for washing a garment, comprising:
washing a garment with the laundry composition according to claim 1; or
washing a garment with a mixture comprising a laundry detergent composition and the laundry composition according to claim 1; or
a) pre-treating the garment with the laundry composition according to claim 1; and
b) washing the pre-treated garment of step a) with the laundry composition according to claim 1, or a laundry detergent composition, or with a mixture comprising a laundry detergent composition and the laundry composition according to claim 1;
wherein the garment comprises at least 50 wt. % of cotton, based on the total weight of the garment.

17. A method of using the laundry composition according to claim 1 as an auxiliary of a laundry detergent composition.

18. A method of using the laundry composition according to claim 1 for the washing of clothes in a washing machine, wherein the clothes comprise at least 50 wt. % of cotton, based on the total weight of the clothes.

19. The laundry composition of claim 1, wherein the laundry composition comprises:
between 0.1 and 1 wt. % of the at least one mannanase, based on the total weight of the laundry composition;
between 0.1 and 1 wt. % of the at least one lipase, based on the total weight of the laundry composition;
between 1 and 3 wt. % of the at least one exocellulase, based on the total weight of the laundry composition;
between 3 and 10 wt. % of the at least one endocellulase, based on the total weight of the laundry composition;
between 0.1 and 1 wt. % of the at least one mannanase, based on the total weight of the laundry composition; and
between 0.1 and 1 wt. % of the at least one amylase, based on the total weight of the laundry composition.

20. The laundry composition of claim 1, wherein the laundry composition comprises between 10 and 15 wt. % of the one or more non-ionic surfactants, based on the total weight of the laundry composition.
